(19) United States
(12) Patent Application Publication
(10) Pub. No.: US 2012/0030471 A1
(43) Pub. Date: Feb. 2, 2012

(54) DOWNLOAD MANAGEMENT SYSTEM

(75) Inventors: HUNG-DA LI, TAIPEI (TW); TIEH-CHIN HSIEH, TAOYUAN COUNTY (TW); YU-YIN KUO, TAIPEI COUNTY (TW)

(73) Assignee: ATP ELECTRONICS TAIWAN INC., TAIPEI (TW)

(21) Appl. No.: 12/944,088

(22) Filed: Nov. 11, 2010

(30) Foreign Application Priority Data
Jul. 28, 2010 (TW) 099124879

(51) Int. Cl. H04L 9/00

(52) U.S. Cl. 713/176

(57) ABSTRACT

A download management system includes a server, a computer host and a storage device. The server stores an encrypted data, which is encrypted according to a certification signature. The computer host is communicatively connected to the server for executing a management program. The storage device is connected electrically to the computer host and includes the certification signature, wherein the download management execution program is capable of reading the certification signature from the storage device, downloading the encrypted data from the server, decrypings the encrypted data according to the certification signature to obtain a decrypted data, and storing the decrypted data in the storage device.

This application which claims the benefits of the Taiwan Patent Application Serial NO. 099124879, filed on Jul. 28, 2010, the subject matter of which is incorporated herein by reference.

### BACKGROUND OF THE INVENTION

1. Field of the Invention

The present invention relates to a download management system, and more particularly to a download management system including a storage device provided with a certification signature so as to prevent from being easily hacked.

2. Description of the Prior Art

Due to the prevalence of computers and the Internet, many information are transmitted via the Internet. Take music and movies for example, before the internet is popular, music and movies are mostly recorded in substantial storage devices such as discs for selling. After the Internet becomes popular, many companies start to put data on the internet server for users to pay for downloading.

However, the biggest problem of transmitting information via the Internet is the infringement of copyrights. Some users may illegally transmit the information to the other users after downloading, which jeopardizes the owner's copyrights.

Responding to the afore-mentioned problem, the prior art demands users to go through the authorization certification. Users must have an account and a password certified by the internet server in order to have access to the data online.

However, many problems still exist. For example, a user merely needs to purchase one account to share the account and the password with the other users. Or users may break into the security system of the internet server to obtain data they want.

### SUMMARY OF THE INVENTION

A download management system is provided in accordance with the present invention to protect encrypted data stored in a server from being easily downloaded if the server is hacked. Moreover, since a user has to prepare a storage device with a certification signature when downloading, it can be avoided that an account is shared by multiple users.

A download management system of the present invention includes a server, a computer host, and a storage device. The server stores an encrypted data, which is encrypted according to a certification signature. The computer host is communicatively connected to the server, and executing a download management execution program. The storage device is electrically connected to the computer host and includes the certification signature. The download management execution program reads out the certification signature from the storage device, downloads the encrypted data from the server, decrypts the encrypted data into a decrypted data according to the certification signature, and stores the decrypted data in the storage device.

According to one preferred embodiment of the present invention, the encrypted data is derived from transferring the decrypted data according to an encrypt/decrypt conversion table and the encrypt/decrypt conversion table is generated by transferring the certification signature via a preset random number generator. Likewise, the decrypted data is derived from transferring the encrypted data according to an encrypt/decrypt conversion table, and the encrypt/decrypt conversion table is generated by transferring the certification signature via a preset random number generator.

According to one preferred embodiment of the present invention, the certification signature is selected from the group of a product identifier (PID) and a vendor identifier (VID).

According to one preferred embodiment of the present invention, the storage device includes a first storage area and a second storage area, and the encrypted data includes a storage location note. After the download management execution program obtains the decrypted data by decrypting the encrypted data, the download management execution program stores the decrypted data in the group of the first storage area and the second storage area according to the storage location note.

According to one preferred embodiment of the present invention, the server further includes a certification unit. The download management execution program sends the certification signature which is read out from the storage device to the server for the certification unit to certify before the download management execution program downloads the encrypted data.

When compared to a conventional download system, the encrypted data stored in the server is encrypted according to the certification signature in advance. Thus, the computer host must be connected to the storage device having the certification signature to decrypt the encrypted data downloaded from the server into the decrypted data and store the decrypted data in the storage device. Unlike the conventional download system, one account can not shared by multiple people, and data is not easily acquired if the server is hacked.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a schematic view of an embodiment of a download management system according to the present invention;

FIG. 2 is a schematic view showing an embodiment of the download management system according to the present invention encrypting/decrypting data with a certification signature; and

FIG. 3 shows a schematic view of a download management interface employed in the download management system of the present invention.

### DETAILED DESCRIPTION OF THE PREFERRED EMBODIMENT

The present invention relates to a download management system, and more particularly to a download management system providing data security. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

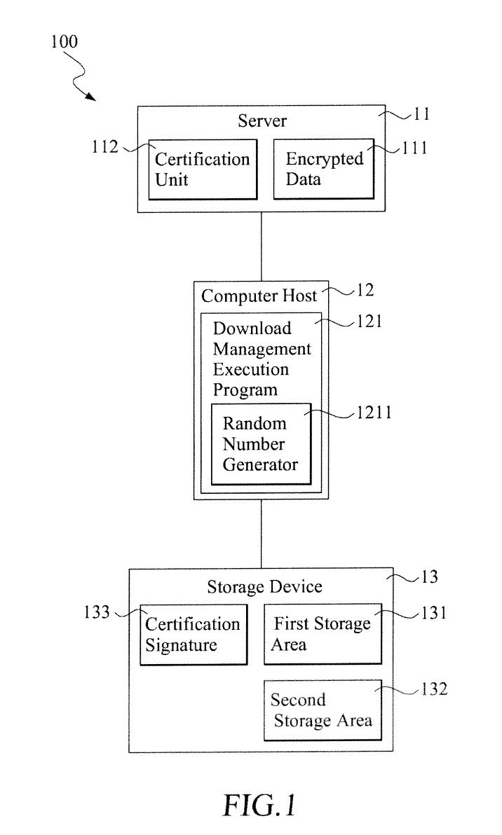

Referring to FIG. 1, a schematic view illustrating an embodiment of a download management system according to of the present invention. The download management system 100 accordingly includes a server 11, a computer host 12, and a storage device 13.

The server 11 stores at least an encrypted data 111, and the encrypted data 111 is encrypted according to at least a certification signature 133. The computer host 12 is communicatively connected to the server 11, and executes a download management execution program 121. The storage device 13 is electrically connected to the computer host 12, and includes the certification signature 133.

Meanwhile, the download management execution program 121 reads out the certification signature 133 from the storage device 13, downloads the encrypted data 111 from the server 11, decrypts the encrypted data 111 into a decrypted data (not shown) according to the certification signature 133, and stores the decrypted data in the storage device 13. In one embodiment of the present invention, after the download management execution program 121 decrypts the encrypted data 111 into a decrypted data, the download management execution program 121 again encrypts the decrypted data according to at least a certification signature 133 stored in the storage device 13 so as to further protect the decrypted data, wherein the certification signature 133 is selected from the group of a product identifier (PID), a vendor identifier (VID) and a serial number (SN).

Since the certification signature 133 is in the storage device 13, if a user tries to decrypt the encrypted data 11, the storage device 13 including a certification signature 133 is needed. Conventionally, an authentication certification is merely performed when a user login an internet server. However, the download management system 100 of the present invention encrypts the encrypted data 111 in advance such that even if the encrypted data 111 is downloaded by a user without the storage device 13, the user is unable to decrypt the encrypted data 111 into a decrypted data.

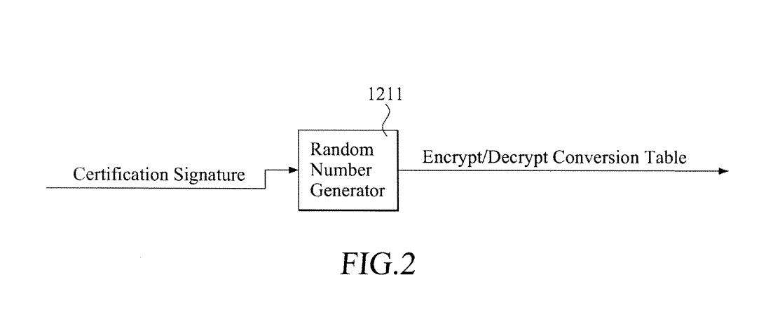

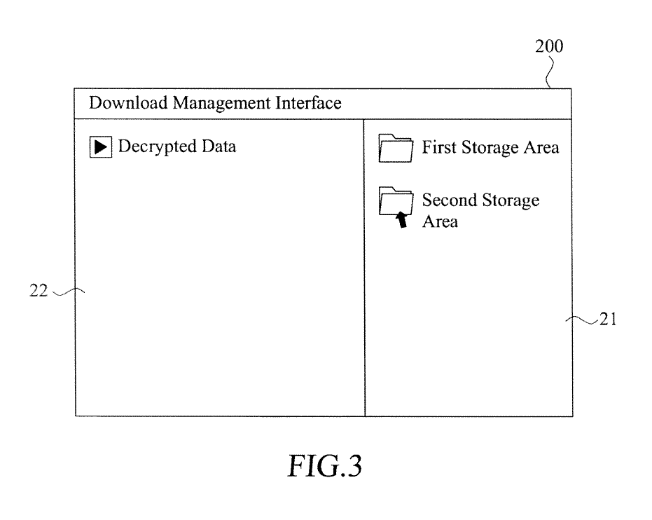

Another embodiment of the present invention shows in a more practical way. Referring to FIG. 2 and FIG. 3 together, a schematic view showing another embodiment of the download management system of the present invention encrypting/decrypting data with a certification signature and a download management interface employed in the download management system. According to one embodiment of the present invention, the certification signature 133 selected from the group of a product identifier (PID) and a vendor identifier (VID). Since a PID and a VID is exclusively owned by a manufacturer and a product of the storage device 13, the process of decryption is more secure.

Moreover, the download management execution program includes a preset random number generator 1211, wherein the encrypted data 111 is derived from transferring the decrypted data according to an encrypt/decrypt conversion table and the encrypt/decrypt conversion table is generated by transferring the certification signature 133 via the preset random number generator 1211. Likewise, the decrypted data is derived from transferring the encrypted data 111 according to an encrypt/decrypt conversion table, and the encrypt/decrypt conversion table is generated by transferring the certification signature 133 via the preset random number generator 1211. Since a rule of generating random numbers of the random number generator 1211 is preset, even if other users acquire the certification signature 133, the encrypted data 111 is not easily decrypted without the random number generator 1211 having the same rule of generating random numbers.

Furthermore, the server 11 further includes a certification unit 112, and the download management execution program 121 sends the certification signature 133 read out from the storage device 13 to the server 11 for the certification unit 112 to certify before the download management execution program 121 downloading the encrypted data 111 from the server 11. As a result, users are unable to easily download the encrypted data 111 from the server 11 by telling others accounts and passwords.

The storage device 13 further includes a first storage area 131 and a second storage area 132, and the encrypted data 111 includes a storage location note (not shown) after encryption. After the download management execution program 121 obtains the decrypted data by decrypting the encrypted data 111, the download management execution program 121 stores the decrypted data in the group of the first storage area 131 and the second storage area 132 according to the storage location note. According to one embodiment of the present invention, the decrypted data is saved as a read-only decrypted data and the second storage area 132 is a hidden area. Only when users browse the storage device 13 via a download management interface 200, can they see the second storage area 132 as the hidden area in a storage area column 21 and see the decrypted data in a data column 22. As a result, the download management system 100 of the present invention automatically saves the decrypted data in the second storage area 132 and users who are to read the decrypted data have to prepare the storage device 13 having the certification signature 133 and to install the download management interface 200 in the computer host 12 for browsing the hidden area, which protects the data effectively.

In conclusion, since the encrypted data 111 stored in the server 11 is encrypted in advance within the download management system 100 of the present invention according to the certification signature 133 according to, the computer host 12 has to be connected to the storage device 13 having the certification signature 133 and has to be installed with the download management execution program 121 having the random number generator 1211 so as to decrypted the encrypted data 111 downloaded from the server 11 and store the decrypted data in the storage device 13. Meanwhile, when the decrypted data is stored in the hidden area by a read-only means, users have to install the download management program 200 in the computer host 12 in order to browse the hidden area in the storage device 13. Therefore, compared with the conventional download management system, the download management system 100 according to the present invention protects multiple users sharing one account or data being easily obtained once the server is broken in.

While the present invention has been particularly shown and described with reference to a preferred embodiment, it will be understood by those skilled in the art that various changes in form and detail may be without departing from the spirit and scope of the present invention.

What is claimed is:

1. A download management system comprising:
a server storing at least an encrypted data, the encrypted data being encrypted according to at least a certification signature;
a computer host communicatively connected to the server for executing a download management execution program; and
a storage device connected electrically to the computer host, and including the certification signature;
wherein, the download management execution program is adapted to read out the certification signature from the storage device, download the encrypted data from the server, decrypt the encrypted data into a decrypted data according to the certification signature, and store the decrypted data in the storage device.

2. The download management system according to claim 1, wherein the encrypted data is derived from transferring the decrypted data according to an encrypt/decrypt conversion table, and the encrypt/decrypt conversion table is generated by transferring the certification signature via a preset random number generator.

3. The download management system according to claim 1, wherein the decrypted data is derived from transferring the encrypted data according to an encrypt/decrypt conversion table, and the encrypt/decrypt conversion table is generated by transferring the certification signature via a preset random number generator.

4. The download management system according to claim 1, wherein the certification signature is selected from the group of a product identifier (PID) and a vendor identifier (VID).

5. The download management system according to claim 1, wherein the storage device further includes a first storage area and a second storage area, the encrypted data including a storage location note, after the download management execution program obtaining the decrypted data by decrypting the encrypted data, the download management execution program storing the decrypted data in the group of the first storage area and the second storage area according to the storage location note.

6. The download management system according to claim 1, wherein the server further includes a certification unit, the download management execution program sending the certification signature read out from the storage device to the server for the certification unit to certify before the download management execution program downloading the encrypted data.
